(19) United States
(12) Patent Application Publication
(10) Pub. No.: US 2002/0186686 A1
(43) Pub. Date: Dec. 12, 2002

(54) Non-server type voice packet communication device and method

(76) Inventor: Meng-Ta Chen, Taipei (TW)

Correspondence Address: BIRCH STEWART KOLASCH & BIRCH, PO BOX 747, FALLS CHURCH, VA, 22040-0747, US

(21) Appl. No.: 09/935,743

(22) Filed: Aug. 24, 2001

(30) Foreign Application Priority Data
Jun. 12, 2001 (TW) 90114200

(51) Int. Cl. H04L 12/66; H04L 12/56

(52) U.S. Cl. 370/352; 370/392; 370/475

(57) ABSTRACT

The invention discloses a non-server type voice packet communication method, which includes an IP address-inquiring step, an IP address receiving step and a voice packet-transmitting step. According to the method, the IP address-inquiring step firstly transmits an IP address-inquiring signal to a non-server type voice packet communication device using dial tones through a PSTN. Then, the IP address-receiving step receives from PSTN an IP address data transmitted from the non-server type voice packet communication device using dial tones. Finally, the voice packet-transmitting step transmits voice packets to the non-server type voice packet communication device according to the IP address data through digital network.

### BACKGROUND OF THE INVENTION

1. Field of Invention

The invention relates to a non-server type voice packet communication device and method. More particularly, it relates to a voice communication device and method that first obtains IP address data using dial tones through a PSTN (Public Switched Telephone Network) and then follows the IP address data to establish a voice packet communication through the network.

2. Related Art

In comparison with the conventional PSTN, transmitting voice signals over a digital network using a VoIP (Voice on Internet Protocol) has a lower cost. Therefore, with the advance in network technologies, the VoIP technology has been widely applied to Internet telephones, web faxing or videoconferences to lower the cost for communications and signal transmissions.

For the Internet telephones, a VoIP gateway is used to convert the analog voice signals of the telephones into a voice packet, which is then transmitted to another VoIP gateway through a digital network. The later VoIP gateway converts the received voice packet back into analog voice signals. Therefore, the user of the first telephone can receive the voice signals so as to communicate with the user of the second telephone.

However, along with the development in network communities and normal enterprise network systems and the prevalent use of modems when to connecting to the Internet, users find new problems when using Internet telephones to communicate with one another. A network server may assign the IP address of the VoIP gateway when it connects to the Internet using a modem or through a LAN (Local Area Network). The VoIP gateway then has a new IP address assigned by the network server each time it connects to the Internet. The VoIP gateway may use the IP address assigned by the network server for internal communication in a LAN, but not for global communication in a WAN (Wide Area Network). In other words, the IP address of the VoIP gateway is not the one registered at or assigned by the InterNIC (Internet Network Information Center). Therefore, the IP address of the VoIP gateway is only public to the LAN but not the WAN. If the IP address of the VoIP gateway is not fixed or not public to the WAN, another electronic device may not be able to establish signal communications with the VoIP gateway.

In response to the above problem, the Internet telephone merchants proposed a solution: dial up the serial number of the hardware first, such as a computer network interface or VoIP gateway, to establish the Internet telephone connection. Although the above method can solve the problem due to unfixed IP addresses, this architecture requires a server to record the hardware's serial number and its IP address so that one can look up the IP address when making an Internet phone call. Once the server cannot function properly, the user will not be able to make the Internet phone calls. It is also very difficult for a user to remember the serial number of the hardware. Moreover, once the hardware is changed, the serial number will be different. As described above, the method creates a lot of inconvenience for the users.

As to the problem that the Internet telephone hardware device IP address is not public to the WAN, the Internet telephone merchants have not found an effective solution. The currently available WAN IP address formats are insufficient for the large number of user computers.

In view of the foregoing, how to facilitate the Internet telephone calls and, in particular, how to avoid remembering tedious serial numbers and to conquer the problem of insufficient WAN IP addresses form an important subject to be studied.

### SUMMARY OF THE INVENTION

An objective of the invention is to provide a non-server type voice packet communication device and method that can use the same telephone number as the conventional telephones to make Internet phone calls.

To achieve the above objective, the invention provides a non-server type voice packet communication method, which includes an IP address inquiring step, an IP address receiving step and a voice packet transmitting step. The IP address-inquiring step transmits an IP address-inquiring signal using a dial tone to a non-server type voice packet communication device through PSTN. The IP address-receiving step receives an IP address transmitted using a dial tone from the non-server type voice packet communication device. The voice packet-transmitting step transmits at least one voice packet to the non-server type voice packet communication device according to the IP address.

The invention also provides a non-server type voice packet communication device, which includes an IP address inquiring module, an IP address receiving module, and a voice packet transmitting module. The IP address-inquiring module transmits an IP address-inquiring signal to another non-server type voice packet communication device using a dial tone. The IP address-receiving module receives an IP address transmitted from another non-server type voice packet communication device using a dial tone. The voice packet-transmitting module transmits at least one voice packet to a non-server type voice packet communication device according to the IP address.

Since the disclosed non-server type voice packet communication device can inquire as to the IP address (the LAN IP address and the corresponding WAN IP address of the network address translator) of another non-server type voice packet communication device using the dial tone through PSTN, it therefore, even if the non-server type voice packet communication device connects to digital network through a NAT (Network Address Translator), two non-server type voice packet communication devices can still make Internet phone calls to each other without being affected by the NAT.

The disclosed non-server type voice packet communication device allows users to make Internet phone calls in the same way as making a conventional phone call. In other words, the user only needs to remember the original telephone number and calls in the traditional way. So the invention greatly simplifies the method and efficiency of making Internet phone calls.

### BRIEF DESCRIPTION OF THE DRAWINGS

The invention will become more fully understood from the detailed description given hereinbelow illustration only, and thus are not limitative of the invention, and wherein:

FIG. 1 is a schematic view showing the combination of the disclosed non-server type voice packet communication device and PSTN, digital network and a telephone according to a preferred embodiment of the invention.

FIG. 2 is a schematic view showing the non-server type voice packet communication device according to a preferred embodiment of the invention.

FIG. 3 is a schematic view showing the data recorded in an IP address record table of the non-server type voice packet communication device according to a preferred embodiment of the invention.

FIG. 4 is a flowchart showing the procedure of the non-server type voice packet communication method according to a preferred embodiment of the invention.

FIG. 5 is a flowchart showing the procedure of the non-server type voice packet communication device inquiring NAT for its IP address according to a preferred embodiment of the invention.

### DETAILED DESCRIPTION OF THE INVENTION

The invention will be apparent from the following detailed description, which proceeds with reference to the accompanying drawings, wherein the same references relate to the same elements.

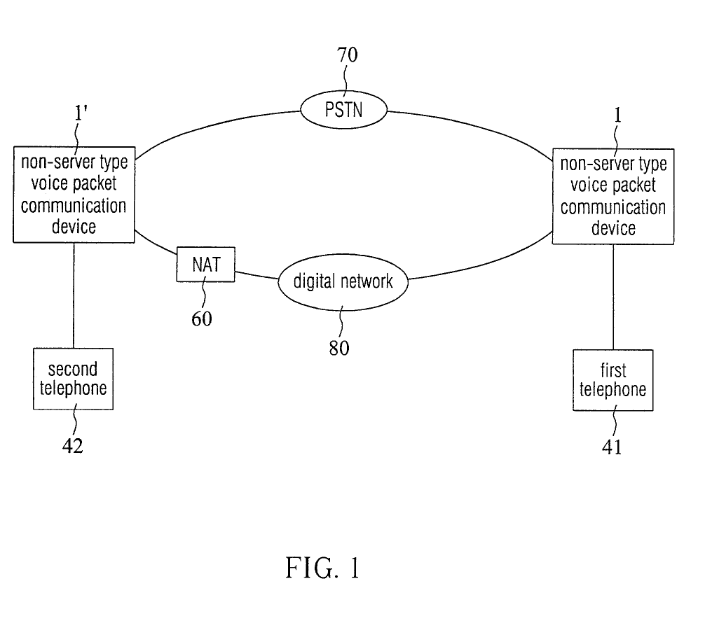

With reference to FIG. 1, a non-server type voice packet communication device 1 and another non-server type voice packet communication device 1′ are connected to a first telephone 41 and a second telephone 42, respectively. Both the telephones are connected to PSTN (Public Switched Telephone Network) 70. Furthermore, the non-server type voice packet communication device 1′ connects to digital network 80 through a NAT (Network Address Translator) 60. The non-server type voice packet communication device 1 connects directly to digital network 80.

Since the non-server type voice packet communication device 1′ couples to digital network 80 via the NAT 60, other electronic devices connecting to digital network cannot know the IP address of the non-server type voice packet communication device 1′. They can only know the IP address converted by the NAT 60. The NAT 60 records the port used by the non-server type voice packet communication device 1′ so as to determine whether any received packet needs to be transmitted to the non-server type voice packet communication device 1.

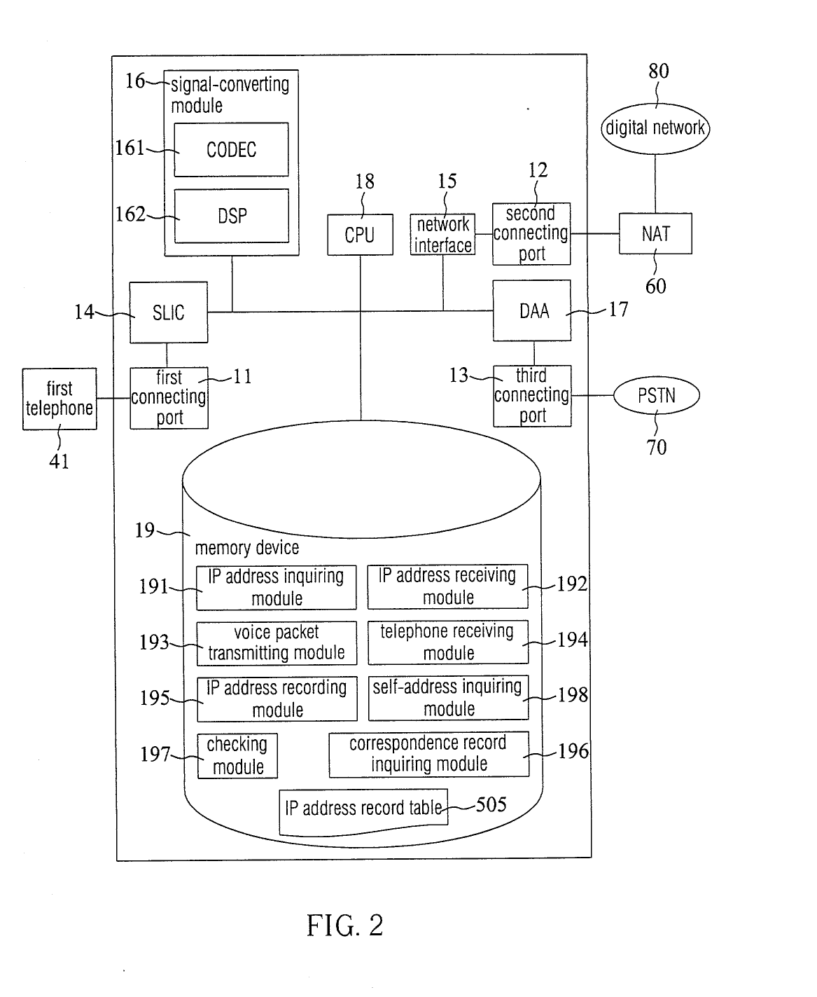

As shown in FIG. 2, the non-server type voice packet communication device 1 includes a first connecting port 11, a second connecting port 12, a third connecting port, an SLIC (Subscriber Line Interface Circuit) 14, a network interface 15, a signal converting module 16, a DAA (Data Access Arrangement) 17, a CPU (Central Processing Unit) 18 and a memory device 19. In the current embodiment, the first connecting port 11 is an RJ-11 connecting port that couples the SLIC 14 and the first telephone 41, transmitting analog voice signals from and to the first telephone 41. The second connecting port 12 is an RJ-45 connecting port that couples the network interface 15 and digital network 80 through the NAT 60, transmitting digital voice packets from and to digital network 80. The third connecting port 13 is an RJ-11 connecting port that couples the DAA 17 and PSTN 70, transmitting analog voice signals from and to PSTN 70.

The signal-converting module 16 mainly converts between digital voice packets and analog voice packets. It includes a CODEC 161 and a DSP (Digital Signal Processor) 162. The CODEC 161 converts analog voice signals into digital voice signals. For example, when analog voice signals from the first telephone 41 through the first connecting port 11 and the SLIC 14 are received, the CODEC 161 first samples the analog voice signals and then converts sampled results into digital voice signals. In addition, the CODEC 161 also processes digital voice signals, such as packaging digital voice signals into digital voice packets that can be transmitted over digital network, gain control, echo cancellation, voice activity detection, and background comfort noise generation. All the details of the above-mentioned signal processing are well known to people skilled in the VoIP technology and therefore are not repeated herein.

The CPU 18 performs the management of a calling procedure and data transmission among the telephones, PSTN 70, and digital network 80. In accordance with the phone number the user dials, the CPU 18 can add in an appropriate header in the digital voice packet transmitted from the signal converting module 16 so that the digital voice packet can be sent to the correct destination in digital network 80.

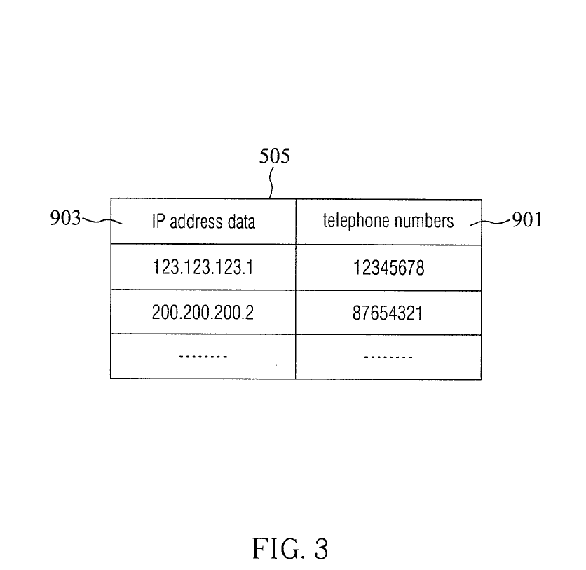

The memory device 19 stores an IP address record table 505. Referring to FIG. 3, the IP address record table 505 stores the correspondent relations between IP address data 903 and telephone numbers 901. These correspondent relations can be entered by users or be automatically stored from previous conversion records. Moreover, in the embodiment, the memory device 19 also stores a plurality of program modules, including an IP address inquiring module 191, an IP address receiving module 192, a voice packet transmitting module 193, a telephone receiving module 194, an IP address recording module 195, a correspondence record inquiring module 196, a checking module 197, and a self-address inquiring module 198. After the CPU 18 reads in all program modules, the CPU can control each hardware device to execute each step in the non-server type voice packet communication method 30 described hereinafter.

In order to make the content in the method proposed by the invention more comprehensible, an explicit embodiment is given below to describe the procedure of the non-server type voice packet communication method 30.

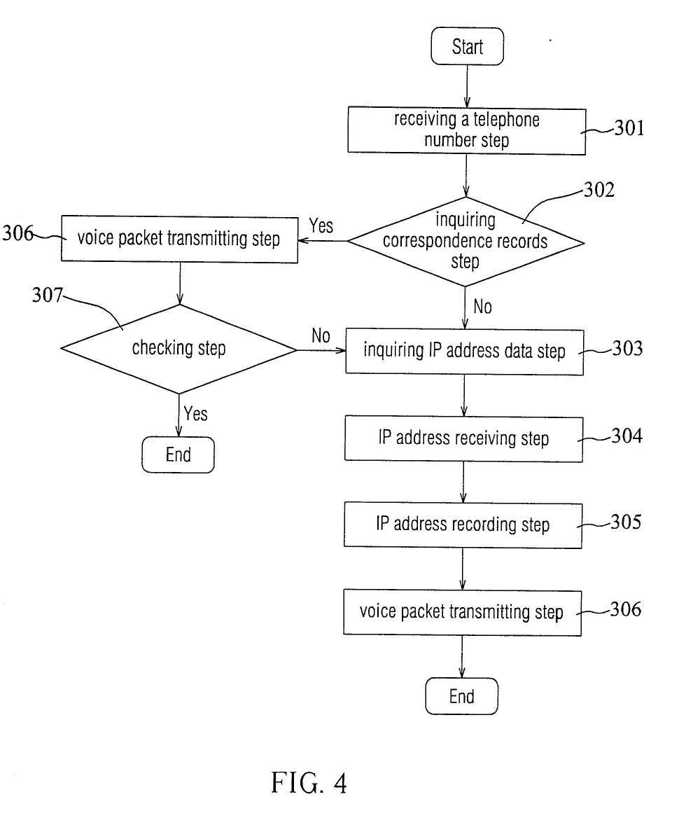

As shown in FIG. 4, the method 30 first performs the step of receiving a telephone number (step 301) to receive the telephone number 901 of the first telephone 41. In this step, the user can use the CCITT standard keypad on the first telephone 41 to dial the phone number and, in addition, a special ID code to tell the non-server type voice packet communication device 1 that it is an Internet phone call. For instance, the user can press “*” before the telephone number 901, meaning that an Internet phone call is desired.

After receiving the telephone number 901 entered by the user, the step of inquiring correspondence records checks the IP address record table 505 as to whether correspondent relations between the IP address data 903 and the telephone numbers 901 already exist (step 302). As described before, the IP address record table 505 in the non-server type voice packet communication device 1 stores the correspondence relations between the IP address data 903 and the telephone numbers 901. Then the message (telephone number 901) is transmitted to the non-server type voice packet communication device 1′ according to the IP address data 903 stored in the IP address record table 505. Afterwards, the step of checking is performed (step 307) and a voice transmission channel is established to transmit voice packets 904.

When the IP address record table 505 does not have the corresponding relationship between IP address data 903 and telephone numbers 901, the step of inquiring IP address data is performed (step 303) to send an IP address inquiring signal 902 to the non-server type voice packet communication device 1′ using dial tones. In this step, the IP address-inquiring signal 902 is a set of predetermined dial tones. When the non-server type voice packet communication device 1′ receives the IP address inquiring signal 902, the communication device 1′ does not try to establish the conversion channel to the second telephone 42 but processes the signal on its own. The IP address of the communication device 1′ and its IP address and port on the NAT 60 are sent to the non-server type voice packet communication device 1 using dial tones.

Afterwards, the IP address receiving step 304 receives the IP address data 903 transmitted from the non-server type voice packet communication device 1′ using the dial tones. The IP address data 903 includes the IP address of the non-server type voice packet communication device 1′, its IP address on the NAT 60, and the port used by the non-server type voice packet communication device 1′ on the NAT 60. The IP address recording step 305 stores the received IP address data 903 in the IP address record table 505.

After receiving the IP address data 903, the voice packet transmitting step 306 sends the voice packet 904 to the non-server type voice packet communication device 1′ according to the IP address data 903. Since the IP address data 903 includes the IP address on the NAT 60 and the port used by the non-server type voice packet communication device 1′ on the NAT 60, the non-server type voice packet communication devices 1 and 1′ can transmit messages back and forth to establish a voice transmission channel. Thus, the voice packet 904 can correctly reach the non-server type voice packet communication device 1′.

The checking step 307 checks whether the voice packet 904 can be successfully sent to the non-server type voice packet communication device 1′. When the voice packet 904 cannot be successfully sent to the non-server type voice packet communication device 1′, the IP address inquiring step 303 is performed to obtain the current IP address data 903 of the non-server type voice packet communication device 1′. In general, if the power of the non-server type voice packet communication device 1′ or the NAT 60 has been turned off, the port used by the non-server type voice packet communication device 1′ on the NAT 60 may be changed or the record in the IP address record table 505 may not be correctherefore, the IP address-inquiring step 303 has to be performed again.

It should be emphasized that any skilled person can use different methods to implement the checking step 307. For example, the non-server type voice packet communication device 1 can transmit the telephone number 901 stored in the IP address record table 505 to the non-server type voice packet communication device 1′ in advance. The non-server type voice packet communication device 1′ then checks whether the received telephone number 901 is its own telephone number. This can prevent incorrect packet transmissions.

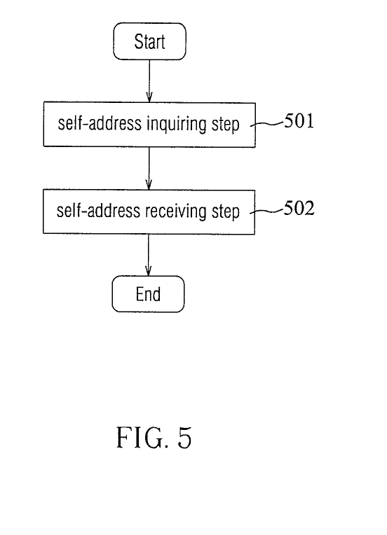

With reference to FIG. 5, when the non-server type voice packet communication device 1′ is turned on, it has to know what its IP address on the NAT 60 is and the port it uses on the NAT 60 is. Therefore, when the dial tone of the IP address-inquiring signal 902 is received, the IP address data 903 can be sent to the non-server type voice packet communication device 1. Accordingly, when turned on, the non-server type voice packet communication device 1′ first performs the self-address inquiring step 501. It transmits a self-address inquiring packet 906 to an IP address analyzer 90. After the NAT 60 receives the self-address inquiring packet 906, the packet 906 is sent to the IP address analyzer 90 through the port used by the non-server type voice packet communication device 1′ on the NAT 60. The IP address analyzer 90 then obtains from the received packet header the IP address and the port used by the non-server type voice packet communication device 1′ on the NAT 60. The IP address data 903 is then sent back to the non-server type voice packet communication device 1′ through the NAT 60. The non-server type voice packet communication device 1′receives the IP address and the port sent from the NAT 60 in the self-address receiving step 502 and stores the two data for further inquiries.

The non-server type voice packet communication device can inquire about the IP address information (including the LAN IP address and the corresponding WAN IP address on the NAT) of another non-server type voice packet communication device using dial tones over PSTN. Therefore, the two non-server type voice packet communication devices can still make Internet phone calls to one another even if they are connected to digital network using a NAT.

The non-server type voice packet communication device allows users to make Internet phone calls in the same way conventional callers dial a phone number. That is, users only need to memorize telephone numbers and dial the phone numbers as before to make Internet phone calls. Thus, the invention greatly simplifies the uses of Internet phone calls.

It should be mentioned that a person familiar with the technologies could make equivalent changes and modifications without departing from the spirit and purview of the invention. For example, some NAT designs can have more than two IP addresses and can make conversions for the non-server type voice packet communication device IP addresses. Under this situation, the non-server type voice packet communication device still has a unique IP address for other electronic devices on digital network. The IP address is, however, an IP address converted by the NAT. In other words, the NAT does not distinguish the non-server type voice packet communication devices according to the ports. At the moment, the IP address can only include the NAT-converted IP address of the non-server type voice packet communication device, but not the port used by the non-server type voice packet communication device on the NAT.

Furthermore, although a software module represents each functional module in the above embodiment, a skilled person can make all or some of the software modules into a specific hardware, such as an ASIC (Application-Specific Integrated Circuit) chip to implement the same function.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A non-server type voice packet communication method, which comprises:
an IP address inquiring step, which transmits an IP address inquiring signal to a non-server type voice packet communication device using dial tones;
an IP address receiving step, which receives an IP address data transmitted from the non-server type voice packet communication device using the dial tones; and
a voice packet transmitting step, which transmits at least one voice packet to the non-server type voice packet communication device according to the IP address data.

2. The method of claim 1, further comprising:
a telephone number receiving step, which receives a telephone number from a first telephone; wherein the IP address inquiring step transmits the IP address inquiring signal to the non-server type voice packet communication device according to the telephone number.

3. The method of claim 1, further comprising:
an IP address recording step, which records the IP address data in an IP address record table that stores the correspondence relations between the IP address data and a telephone number.

4. The method of claim 3, further comprising:
a correspondence record inquiring step, which checks whether the correspondence relation for the IP address data and the telephone number already exists in the IP address record table and transmits to voice packet according to the IP address data stored in the IP address record table when the relation exists.

5. The method of claim 1, further comprising:
a checking step, which checks whether the voice packet is successfully sent to the non-server type voice packet communication device.

6. The method of claim 5, wherein the IP address inquiring step is performed when the voice packet cannot be successfully sent to the non-server type voice packet communication device.

7. The method of claim 1, wherein the non-server type voice packet communication device couples to an NAT (Network Address Translator); and the non-server type voice packet communication device receives the voice packet transmitted in the voice packet-transmitting step.

8. The method of claim 7, further comprising:
transmitting a self-address inquiring packet from the non-server type voice packet communication device to the NAT; and
receiving the IP address data transmitted from the NAT according to the self-address inquiring packet to the non-server type voice packet communication device.

9. The method of claim 8, wherein the self-address inquiring packet is transmitted to an IP address analyzer through the NAT, and the IP address analyzer sends the IP address data in the header of the self-address inquiring packet back to the non-server type voice packet communication device.

10. The method of claim 7, wherein the IP address data include the IP address and the port used by the non-server type voice packet communication device on the NAT.

11. A non-server type voice packet communication device, which comprises:
an IP address inquiring module, which transmits an IP address inquiring signal to a second non-server type voice packet communication device using dial tones;
an IP address receiving module, which receives an IP address data transmitted from the second non-server type voice packet communication device using the dial tones; and
a voice packet transmitting module, which transmits at least one voice packet to the second non-server type voice packet communication device according to the IP address data.

12. The device of claim 11, further comprising:
a telephone number receiving module, which receives a telephone number from a first telephone; wherein the IP address inquiring module transmits the IP address inquiring signal to the non-server type voice packet communication device according to the telephone number.

13. The device of claim 11, further comprising:
an IP address recording module, which records the received IP address data in an IP address record table that stores the correspondence relations between the IP address data and a telephone number.

14. The device of claim 11, further comprising:
a correspondence record inquiring module, which checks whether the correspondence relation for the IP address data and the telephone number already exists in the IP address record table and transmits to voice packet according to the IP address data stored in the IP address record table when the relation exists.

15. The device of claim 14, further comprising:
a checking module, which checks whether the voice packet is successfully sent to the non-server type voice packet communication device.

16. The device of claim 11, wherein the second non-server type voice packet communication device couples to an NAT (Network Address Translator); and the second non-server type voice packet communication device receives the voice packet through the NAT.

17. The device of claim 16, further comprising:
a self-address inquiring module, which transmits a self-address inquiring packet to the NAT.

18. The device of claim 17, wherein the self-address inquiring packet is transmitted to an IP address analyzer through the NAT, and the IP address analyzer sends the IP address data in the header of the self-address inquiring packet back to the non-server type voice packet communication device.

19. The device of claim 16, wherein the IP address data include the IP address and the port used by the non-server type voice packet communication device on the NAT.

20. The device of claim 19, wherein the IP address data further includes the IP address of the non-server type voice packet communication device.
